(19) United States
(12) Patent Application Publication
(10) Pub. No.: US 2017/0022119 A1
(43) Pub. Date: Jan. 26, 2017

(54) DELAYED RELEASE FERTILISING PRODUCT, MANUFACTURING AND SPREADING METHODS

(71) Applicant: AGRO INNOVATION INTERNATIONAL, Saint-Malo (FR)

(72) Inventors: Yves ALIS, Saint-Malo (FR); Anne-Francoise BLANDIN, Pleurtuit (FR); Javier ERRO, Saint-Malo (FR); Jose-Maria GARCIA-MINA, Saint-Malo (FR); Vincent JACQUOT, Saint-Malo (FR); Oscar URRUTIA, Saint-Malo (FR); Jean-Claude YVIN, Saint-Malo (FR); Andre ZANBINI, Saint-Malo (FR)

(21) Appl. No.: 15/301,158

(22) PCT Filed: Apr. 1, 2014
(86) PCT No.: PCT/FR2014/050780

§ 371 Date: Sep. 30, 2016

(51) Int. Cl. C05G 3/00; C05B 17/00

(52) U.S. Cl. CPC C05G 3/0035; C05B 17/00; C05G 3/0041

(57) ABSTRACT

The invention relates to a fertilizing product, for example a potash fertilizer, the release of which is controlled and delayed by a coating comprising a first layer based on a polysaccharide resin obtained from a vegetable oi, and a second layer based on a non-hydrated cement.

The present invention relates to a fertilizing product, the release profile of which in the soil by gradual dissolution is particularly suitable for climates with intense rainfall and also for climates with high rainfall. A subject of the invention is also a process for producing such a fertilizer which implements a granulating step and a coating step.

### TECHNOLOGICAL BACKGROUND

Inorganic fertilizers are generally very water-soluble, and risk being rapidly leached into the soil by instances of precipitation or watering, before being absorbed by the plant.

It is consequently difficult to maintain the effect of a fertilizer over a relatively long period of time owing to the loss of nutrients from the fertilizer by leaching. In addition, crops have a tendency to be damaged by the rapid release of an excessive amount of nutritive elements or of dissolved salts.

Slow-release fertilizers are consequently sought in order to reduce the loss of nutritive elements from fertilizers exposed to large amounts of water.

To this effect, it has been proposed to coat granular fertilizers with organic coatings (resins, oils) and/or inorganic coatings (talc, cement, diatomaceous earth).

The coating of fertilizer with a mixture of magnesite cement and oil has been described, for example, in patent U.S. Pat. No. 5,630,861. Crystals pre-encapsulated by a magnesite cement are agglomerated by joint granulation/compression or pelletizing of the crystals encapsulated with the same solution of magnesite cement. The agglomerates obtained are again coated with the same solution of magnesite cement and oil.

In patent application US 2011/0126602, urea particles are coated by spraying an aqueous dispersion of a urethane-modified alkyd resin, and then with a talc, calcium carbonate or diatomaceous earth powder of less than 5 microns in diameter.

However, the inventors have found that a second layer consisting of talc according to the teaching of this document does not make it possible to effectively delay the release of a potassium-based fertilizer, in particular when the soil is subjected to intense rains.

U.S. Pat. No. 4,023,955 has proposed the coating of urea with a hydrated cement in order to improve the adhesion of the coating to the fertilizer. The cement layer is covered with a thin layer of latex in order to prevent agglomeration of the coated cement particles which are very hygroscopic.

Nevertheless, there remains the need to develop delayed-release fertilizing products which are suitable in particular for regions where the soils undergo considerable leaching due to abundant or intense precipitations. The gradual-release fertilizing products make it possible to adjust the amount of nutrients to the nutritive demand of the plant, and to avoid high peaks of nutritive material concentration in the soil in the event of high rainfall.

### SUMMARY OF THE INVENTION

The present invention is based on the water-dissolution properties of certain resins, which make them candidates that are particularly suitable for coating fertilizer in order to modulate the availability thereof to the plant according to precipitation volume.

According to a first aspect, the delayed-release fertilizer comprises a first layer of resin, and a second layer of cement, preferably non-hydrated cement.

For the purposes of the invention, the term “delayed release” is intended to mean that the water-dissolution profile, in a column of soil or in the soil, of the coated fertilizer, is modified relative to the dissolution profile of the same uncoated fertilizer. More specifically, the rate of dissolution of the fertilizer of the invention is slowed down by virtue of the coating, so that the nutritive elements are made available to the soil in a manner that is controlled and modified, or even prolonged over time. Furthermore, the release of the nutritive elements in water can be delayed over time, in the sense that significant amounts of fertilizer are released only starting from a certain time from the beginning of exposure of the coated fertilizer to an aqueous medium. Finally, the release of the fertilizer of the invention can be advantageously modulatable according to the meteorological conditions, in particular according to the precipitation volume and/or flow rate.

The resin is applied to the surface of fertilizer particles preferably from an aqueous dispersion of resin.

According to one particular embodiment, the fertilizer comprises a potassium salt, and it is coated with a first layer comprising the polymer resin, then with a second layer consisting of a cement, preferably a non-hydrated cement.

Resin

The resin has the advantage of degrading in the soil and of being converted into biodegradable fragments. It also has the advantage of being able to adjust the fertilizer release control or delay effect, as a function of the environmental conditions, and in particular the rainfall.

The resin used for coating the fertilizer is preferably in the form of an aqueous dispersion containing for example between 20% and 40% by weight of water, and optionally another solvent such as a glycol.

For the purposes of the invention, the term “dispersion” is intended to mean a dispersion in the strict sense of resin particles in water, and also an emulsion containing resin particles dispersed in water by means of a surfactant. The words dispersion and emulsion can be used interchangeably in the remainder of this description.

The resin can be chosen from polysaccharides and polyesters obtained from unsaturated natural triglycerides.

A polysaccharide is for example chosen from the group composed of cellulose and esterified derivatives thereof (methylcellulose, hydroxypropylmethylcellulose, ethylcellulose), starches and derivatives thereof, pectins and methylated derivatives thereof, and gums such as carraghenans, alginates, agar, gum Arabic, xanthan gum, pullulan gum, gellan gum and chitosans.

The resin can also be obtained from a vegetable oil and from a compound chosen from vinyl monomers, polycarboxylic acids and anhydrides.

Among the anhydrides, mention may be made of maleic anhydride and phthalic anhydride. Among the polycarboxylic acids, mention will be made of citric acid, succinic acid and polylactic acid.

As unsaturated natural triglyceride or vegetable oil, mention may be made of castor oil, palm oil, corn oil, soybean oil, rapeseed oil, sunflower oil, sesame seed oil, peanut oil, safflower oil, olive oil, cottonseed oil, linseed oil, coconut oil and tung oil, and mixtures thereof.

The vegetable oil may be modified by oxidation (epoxidized vegetable oil) or by reaction with acrylic acid or maleic anhydride. Thus, the modified vegetable oil can be chosen from epoxidized soybean oil, maleinized soybean oil, acrylic-based soybean oil, epoxidized linseed oil, maleinized linseed oil, epoxidized acrylic-based linseed oil, epoxidized castor oil, maleinized castor oil and acrylic-based castor oil.

According to a first embodiment, the resin may be a branched polyester obtained by copolycondensation reaction of a vinyl monomer such as modified styrene with a vegetable oil, in the presence of an amine or of an ammoniacal solution in order to neutralize the acid groups during the polymerization reaction and to allow the incorporation of the polymer into water. The amine may be chosen from triethylamine, N,N-dimethylethanolamine, trimethylamine, ethanolamine, N,N-diethylethanolamine, N-methylethanolamine, N-methylethanolamine, monoisopropanolamine, butanolamine, ethylenediamine, diethylamine and the like.

The vinyl monomer may be chosen from (meth)acrylic monomers and esters thereof, styrene and alkylated derivatives thereof, vinyl ethers, and mixtures thereof. Styrene or a (meth)acrylic derivative is for example used.

According to a second embodiment, the resin may be a polyester obtained by reaction of a (meth)acrylic monomer, such as acrylic acid, with an epoxidized vegetable oil, optionally in the presence of a glycol.

Among the glycols, mention will be made of ethylene glycol, propylene glycol or butylene glycol.

According to one particular embodiment, the resin is obtained from the mixture of the following starting materials: castor oil, soybean oil, linseed oil, acrylic acid or styrene.

According to another particular embodiment, the resin is a polyester resin which can be obtained by reaction of at least one polyol with a polycarboxylic acid or an anhydride, optionally in the presence of a vinyl compound as previously described or of a vegetable oil.

The polyol may be chosen from glycerol, trimethylolpropane, diethylene glycol, saccharides such as pentaerythritol, sorbitol and mannitol, ethylene glycol, neopentyl glycol, 1,4-butanediol, 1,6-hexanediol, propylene glycol, 1,3-butylene glycol, pentanediol, dipropylene glycol, triethylene glycol, trimethylolethane, methylglucoside, dipentaerythritol and sorbitol, or a mixture thereof.

The polycarboxylic acid or the anhydride are for example chosen from maleic acid, maleic anhydride, fumaric acid, caproic acid, capric acid, adipic acid, benzoic acid, phthalic acid, phthalic anhydride, m-phthalic acid, trimellitic acid and mixtures thereof. An aromatic acid anhydride is preferred.

The resin used for coating the fertilizer is preferably in the form of an aqueous dispersion containing for example between 20% and 40% by weight of water, and optionally another solvent such as a glycol (butylene glycol or propylene glycol, for example).

The acid number of the resin ranges for example from 10 to 350 mg of KOH/g of resin, preferably from 20 to 200 mg of KOH/g of resin. In one embodiment, the number ranges from 30 to 80 mg of KOH/g of resin, or from 40 to 70 mg of KOH/g of resin.

The resin can have a weight-average molecular weight (Mw) in the range of from 1000 to 5 000 000 daltons, for example from 3000 to 1 000 000 daltons, or from 5000 to 500 000 daltons.

Cement

For the purposes of the invention, the term “cement” is intended to mean a mixture of calcium silicates and aluminates, resulting from the combination of lime (CaO) with silica (SiO₂), alumina (Al₂O₃) and iron oxide (Fe₂O₃). The lime can be provided by limestone rocks, while the alumina, the silica and the iron oxide can be provided by clays. Magnesium oxide-based magnesite cements are excluded from this definition.

The cement may be non-hydrated in the sense that it contains only minute traces of water; for example, water is not added during the step of coating with the cement.

The cement is preferably chosen from Portland cements, composite cements, an aluminous cement or a mixture comprising one of the various types of cements mentioned above.

According to standard EN 197-1, a composite cement comprises a Portland cement and one or more alternative materials such as siliceous and calcareous flyash, a blast furnace slag, a natural or synthetic calcined pozzolan, a silica fume, a calcined schist or limestone filler, or a metakaolin.

In steel making, slag is a by-product of metallurgy containing metal oxides, essentially silicates, aluminates and lime, which are formed during melting or production of metals by the liquid process.

Pozzolans are compounds of the type such as aluminosilicates or siliceous compounds or calcium aluminosilicates such as calcined clays, natural or synthetic calcined pozzolans, natural or calcined volcanic ash, kaolins, metakaolins, flyash from power stations, biomass flyash, silica fumes, quartz flour, rice husk ash, blast furnace slags, totally amorphous compounds such as ground soda-lime glasses with a high silica content, glass powders, natural or calcined volcanic ash.

The term “Portland cement or blended cement” is intended to denote, without implied difference, any cement defined according to standard EN 197-1:2000. All the combinations of cements mentioned in standard EN 197-1:2000 are also possible for preparing the cement of the invention. Preferably, the Portland cement is selected from at least one of the following cements: a CEM I 52.5 N and R Portland cement (standard EN 197-1:2000), and a CEM I 42.5 N and R Portland cement (standard EN 197-1:2000), CEM I 32.5 N and R Portland cement, and a blended cement of CEM II, III, IV or V type, for example a cement of CEM II/B-M type, or of CEM II-Z-32 type.

In Brazil, Portland cements are classified in eleven categories: common Portland cement (CP I), composite Portland cement (CP II) with slag (CP II-E), pozzolan (CP II-Z) or X (CP II-F), blast furnace Portland cement (CP III), pozzolanic Portland cement (CP IV), high initial strength Portland cement (CP V-ARI), sulfate-resisting Portland cement (RS), Portland with low hydration heat (BC), and white Portland cement (CPB). The cement used in the context of the invention may be a CPB-40 cement, or a CEM IV-32 or CEM V-ARI or CP-V-ARI RS cement.

In one particular embodiment, the cement is a Portland cement of CEM II/B-M (LL-V) 42.5 R CE CP2 NF type, or a blended cement of CEM IV-32 or CP IV-32 type.

The cement may be a Portland cement or a blended cement containing 15% to 50% by weight of pozzolans.

The cement may advantageously contain from 70% to 80% by weight of clinker, from 10% to 15% by weight of limestone, from 10% to 15% by weight of ash, and from 3% to 4% by weight of gypsum.

The cement preferably has a particle size of less than 100 μm (i.e. at least 50%, preferably at least 99% by weight of the cement comprises particles which pass through a 100 μm sieve) and greater than 5 microns. The cement preferably has an average particle size D50 of less than 50 μm and greater than or equal to 10 μm.

The cement according to the invention can have an absolute density greater than or equal to 2.6 g/cm³, and generally an absolute density less than or equal to 32 g/cm³. Its Blaine specific surface area (measured according to standard NF 196-6) is preferably greater than 4000 cm²/g, preferably about from 4400 cm²/g to 5200 cm²/g. The Blaine fineness is for example about 4500-4600 cm²/g.

### Fertilizing Product

The fertilizing product can be chosen from fertilizers and soil enrichers, and generally any other water-soluble plant nutrition compound.

The fertilizers to be coated are preferably in the form of granules that can be obtained by compression, prilling or granulation or by mixing granules of this type. The size of the granules is generally about from 1 to 5 mm.

The fertilizer may be chosen from simple fertilizers or binary or ternary composite fertilizers.

The fertilizer may thus be an NPK fertilizer, in the sense that it can contain a nitrogen source and/or a phosphorus source and/or a potassium source. The NPK fertilizer preferably contains a potassium source.

The fertilizing product of the invention can for example contain one or more fertilizing materials chosen from urea, ammonium phosphates, ammonium sulfate, ammonium nitrate, natural phosphate, single superphosphate, triple superphosphate, potassium chloride or sulfate, magnesium nitrate, manganese nitrate, zinc nitrate, copper nitrate, phosphoric acid and boric acid.

The product of the invention may be in the form of a product chosen from root fertilizers, foliar fertilizers or else nutritive root solutions.

The present invention can be used in the fertilization of a very large variety of plants. Among these, mention will in particular be made of:
large crop plants such as cereals (wheat, corn),
protein-yielding plants (pea),
oil-yielding plants (soybean, sunflower, rapeseed),
meadow plants for animal feed,
specialized crops such as, in particular, sugar crops (sugar cane, beet), market gardening (lettuce, spinach, tomato, melon), grapevine, arboriculture (coffee, cocoa, pear, apple, nectarine), or horticulture (rose bushes).

In the present application, the expression “plant” is intended to denote the plant considered as a whole, including its root system, its vegetative system, the grains, seeds and fruits.

The cement preferably represents from 0.5% to 9% by weight of the weight of the uncoated fertilizer, preferably from 1% to 7% by weight, more preferably from 3% to 5.5%.

The resin in the form of an emulsion used for coating the fertilizer represents for example from 0.1% to 5% of the weight of the uncoated fertilizer, preferably from 0.5% to 4% by weight, for example between 1.5% and 2%.

The weight ratio of the resin to the cement is preferably between 1/1 and 1/6, preferably between 1/2 and 1/5.

### Production Process

A subject of the invention is also a process for producing a fertilizing product as described above, in a step of producing the granules by granulation, compression or prilling and then in a coating step which consists in spraying an aqueous dispersion of resin onto the fertilizer particles, then in adding non-hydrated cement powder to these resin-coated fertilizer particles.

The coating step is carried out either on leaving the granule formation process or by taking granules already formed (blend). In any event, the granules preferably have a temperature of from 30° C. to 50° C. when they enter the coater.

The coating method envisioned can be applied to all coating processes in which the granules are moved, such as fluidized beds, rotary drums, or mobile tank mixers or arm mixers.

According to one particular embodiment, the presence of a drying agent, such as a cobalt salt or a manganese salt, is not necessary during the coating of the fertilizer with the resin.

The resin and the cement can be applied in the same apparatus and, preferentially, the resin will be sprayed onto the granules before distributing the cement thereon. In addition, those skilled in the arc will be able to adjust the resin spraying temperature so as to obtain a viscosity suitable for uniform and rapid distribution of the resin on the granules to be coated.

The resin in emulsion, which is preferably preheated, is uniformly sprayed onto the fertilizer particle using a nozzle so as to form a uniform polymer film. The amount of resin is adjusted relative to the size, to the shape and to the roughness of the fertilizer particles.

The fertilizer thus coated can optionally undergo an anti-caking treatment known to those skilled in the art in order to limit the aggregation of the particles during storage of the product.

### Spreading Process

A subject of the invention is also a process for spreading a fertilizing product on soils that may be subjected to a daily rainfall of between 150 and 500 mm of water and/or to an annual rainfall of between 2000 and 3000 mm of water, which consists in using the fertilizing product described above, for example at a dose of between 100 and 250 kg/ha.

### DESCRIPTION OF THE FIGURES

FIG. 1. Electrical conductivity of the leachate obtained on a column of sandy soil and simulation of intense rain (1 day) for a coated fertilizer according to the invention (sample C) and the same fertilizer uncoated (reference A).

FIG. 2. Electrical conductivity of the leachate obtained on a column of sandy soil and simulation of moderate rain (10 days) for a coated fertilizer according to the invention (sample C) and the same fertilizer uncoated (reference A).

FIG. 3. Amount of potassium in a leachate obtained on a column of sandy soil and simulation of intense rain (1 day) for a coated fertilizer according to the invention (sample B) and the same fertilizer uncoated (reference A).

FIG. 4. Amount of potassium in a leachate obtained on a column of sandy soil and simulation of moderate rain (10 days) for a coated fertilizer according to the invention (sample B) and the same fertilizer uncoated (reference A).

FIG. 5. Amount of nitrogen in a leachate obtained on a column of sandy soil and simulation of intense rain (1 day) for a coated fertilizer according to the invention (sample B) and the same fertilizer uncoated (reference A).

FIG. 6. Amount of nitrogen in a leachate obtained on a column of sandy soil and simulation of moderate rain (10 days) for a coated fertilizer according to the invention (sample B) and the same fertilizer uncoated (reference A).

FIG. 7. Dry weight of soy shoots exposed at four doses of fertilizer according to the invention (sample B) or of uncoated fertilizer (reference A).

FIG. 8. Electrical conductivity of an NPK fertilizer (7 0 20) coated according to the invention and of the same fertilizer coated with a resin and with talc, produced on the laboratory scale.

FIG. 9. Electrical conductivity of an NPK fertilizer (3 0 49) coated according to the invention and of the same fertilizer coated with a resin and with talc, produced on the laboratory scale.

### DESCRIPTION OF THE METHODS

1^{st} Method of Evaluating the Delay in Release: Measurement and Monitoring of Electrical Conductivity:

### Material:

multimeter (pH, conductivity, OD, etc.) HQ40d (supplier: Hach);
2 l short beaker;
IKA magnetic stirrer (lab number 532),
magnetic bar 70 mm long, 10 mm wide,
stainless steel funnel with fine meshes, through which a rod passes (to be placed on the beaker).

### Protocol:

fill the beaker with 2 l of tap water;
stir so as to obtain a slight vortex (speed 5 on the IKA, approximately 45 rpm),
place the funnel with the rod on the beaker so as to place the funnel at the center of the beaker,
immerse the conductivity electrode in a defined zone, at the “periphery”, which will always be the same for the entire series of measurements. Preferentially, the electrode is located close to the wall of the beaker and its tip is placed at the level of the 1.5 l graduation,
wait for the water conductivity measurement to be stable (often approximately 450-470 μS/cm) and record this reference conductivity;
sieve the product to be analyzed between 3.15 and 4 mm; then weigh out 5.0 g of sieved product and place in the funnel;
launch a continuous conductivity measurement over a period of 30 minutes with a recording point every 30 seconds;
at the end of the 30 minutes, stop the recording of the conductivities and plot the curve of change in conductivity of the solution as a function of time,
note down particularly the values of the conductivities measured at t+3 min, t+15 min and t+30 min, relating the values of the conductivities measured on the uncoated fertilizer to the values of the conductivities measured on the coated fertilizer, calculate the conductivity reduction factor due to the coating.

2^{nd} Method for Evaluating the Delay in Release: Leaching in a Soil Column:

The principle of these tests is to deposit a few granules of fertilizer on a soil column, to simulate rainfall by sprinkling these granules with a known frequency and a known amount of water, then to recover, at the bottom of the soil column, the leachates for analysis.

The soil columns are PVC cylinders 40 cm high and 7.5 cm in diameter, filled with 2.3 kg of earth or of sand, and on which the fertilizer granules are deposited at a rate of 100 kg/ha. The additions of water simulate 3 types of rain:
intense rains: 300 mm “continuously” or 10 times 30 mm in 1 day;
gentle rains: on a soil that is always wet, ‘rains’ of 300 mm in 30 days at an addition every 3 days for 30 days,
intermediate or moderate rainfall: ‘rains’ of 300 mm in 10 days.

For each type of rain, the leachates are collected at the bottom of the column and analyzed by measuring their conductivity and their N, P, K, S or Mg content, so as to plot the change in the amount of nutrient leached over time or as a function of the amount of rain.

### EXAMPLES

### Example 1 of the Invention

### Coating of the NPK Fertilizer (03-00-49)

### A-Preparation

One tonne (T) of an NPK fertilizer (03-00-49 produced by wet granulation), in the form of granules, was coated successively with a resin in aqueous dispersion and then with a cement, in variable proportions. An anti-caking treatment can optionally be carried out.

The CEM II/B-M (LL-V) 42.5R CE CP2 NF cement is for example supplied by the company Lafarge Ciments (Blaine fineness equal to 4542 cm²/g).

| | | Dose | | Dose |
|---|---|---|---|---|
| Sample | Resin | [kg/T] | Cement | [kg/T] |
| Reference A | — | | — | |
| (uncoated) | | | | |
| B | resin R | 15 | CEM II/B-M 42.5R | 40 |
| C | resin R | 10 | CEM II/B-M 42.5R | 30 |
| D | resin R | 10 | CEM II/B-M 42.5R | 30 |
| E | Emultech 040 ® | 10 | CEM II/B-M 42.5R | 70 |
| F | Polymul A40 ® | 10 | CEM II/B-M 42.5R | 30 |
| G | resin R | 10 | CPB-40 | 30 |
| H | resin R | 10 | CP V-ARI RS | 30 |
| I | resin R | 10 | CP IV-32 | 30 |

Resin R: supplied by the company Luengo Color, aqueous dispersion of a branched polyester obtained by copolycondensation reaction of a vinyl monomer such as a modified styrene, with a mixture of soybean oil, of linseed oil and of castor oil, in the presence of an ammoniacal solution. The dispersion also contains butylene glycol.

Emultech 040®: resin supplied by the company WTechQuimica, aqueous dispersion of a polysaccharide.

Polymul A40®: resin supplied by the company Biofragane, polysaccharide-based polyemulsion.

### B. Results of Conductivity by Dissolution in Water:

The tests were carried out on the Reference A to I samples according to the first method previously described.

| | Conductivity | | | Reduction factor | | |
|---|---|---|---|---|---|---|
| Sample | 3 min | 15 min | 30 min | 3 min | 15 min | 30 min |
| Reference A | 1772 | 3332 | 3539 | | | |
| (uncoated) | | | | | | |
| B | 56 | 171 | 269 | 31.8 | 19.5 | 13.2 |
| C | | | 2194 | | | 1.6 |
| D | 405 | 1283 | 1981 | 4.5 | 2.6 | 1.8 |
| E | 703 | 1895 | 2609 | 2.6 | 1.8 | 1.4 |
| F | 688 | 1963 | 2661 | 2.7 | 1.7 | 1.4 |
| G | 495 | 1521 | 2263 | 3.7 | 2.2 | 1.6 |
| H | 513 | 1409 | 1943 | 3.6 | 2.4 | 1.9 |
| I | 209.7 | 731 | 1189 | 8.7 | 4.6 | 3.0 |

Results: The conductivity in the leachates (CE) obtained with sample C begins to increase from the 4^{th} day (90 mm of added water) in the two systems (intense rain and moderate rain). The conductivity of the leachates of sample C is lower in the intense rain system (1 day). The release profile is delayed.

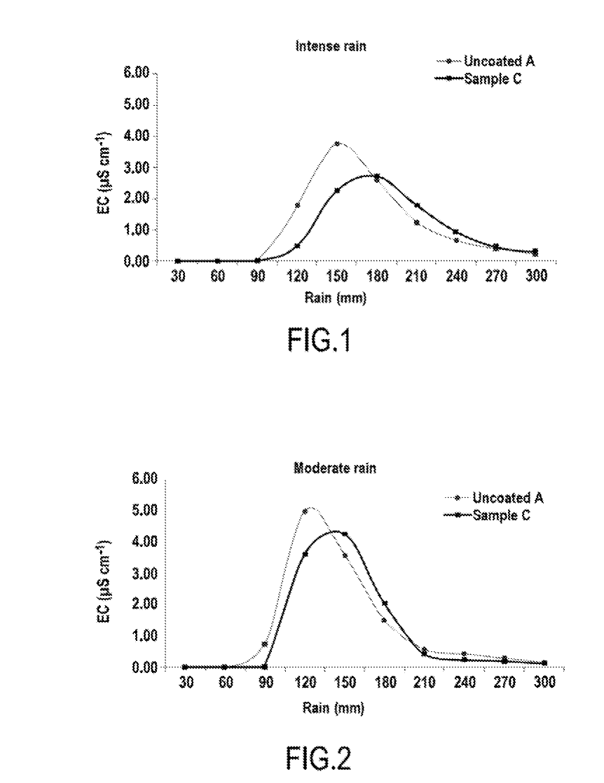

The period of greatest effectiveness of sample C is between the 4^{th} and the 7^{th} day. Starting from the 8^{th} day, the differences are small (FIGS. 1 and 2).

The fertilizer of the invention clearly makes it possible to modulate the making available of potassium to the plant as a function of the precipitation volume. It is particularly effective when the soil is exposed to intense rains. The coating of the invention makes it possible to modulate the fertilizer release profile as a function of the meteorological conditions.

### C. Results on a Soil Column for the Reference A (Uncoated) and B Samples

The tests are carried out on sample B according to the second method previously described, with a sandy soil from the Iguazu region (sand 92%, clay 6% and silt 2%; pH_{(H}_{₂}_{O)} 5.38; Ca 1.55; Mg 0.19; K 0.06 cmol, dm⁻³; CEC 3.42 cmol_{c} dm⁻³; P 3.80 mg dm⁻³; organic carbon 1.6 g dm⁻³). The leachates are collected from the substrate at the heights 0-20 and 20-40 cm.

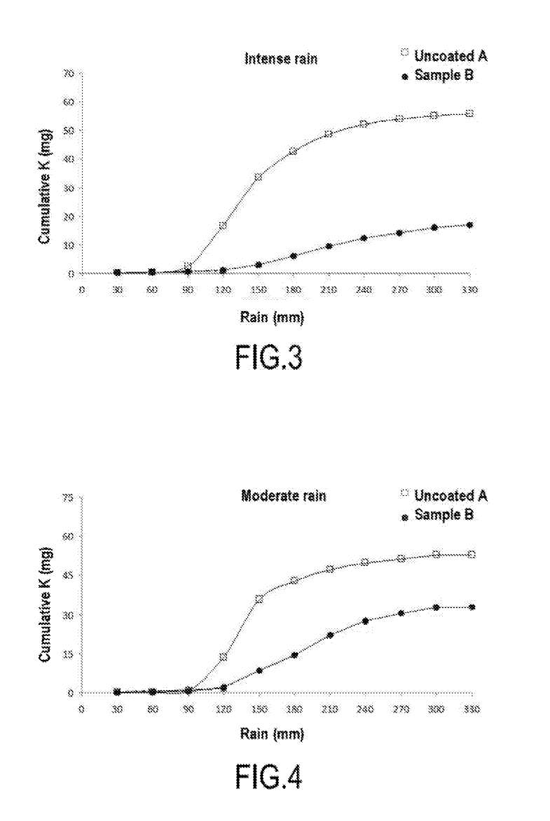

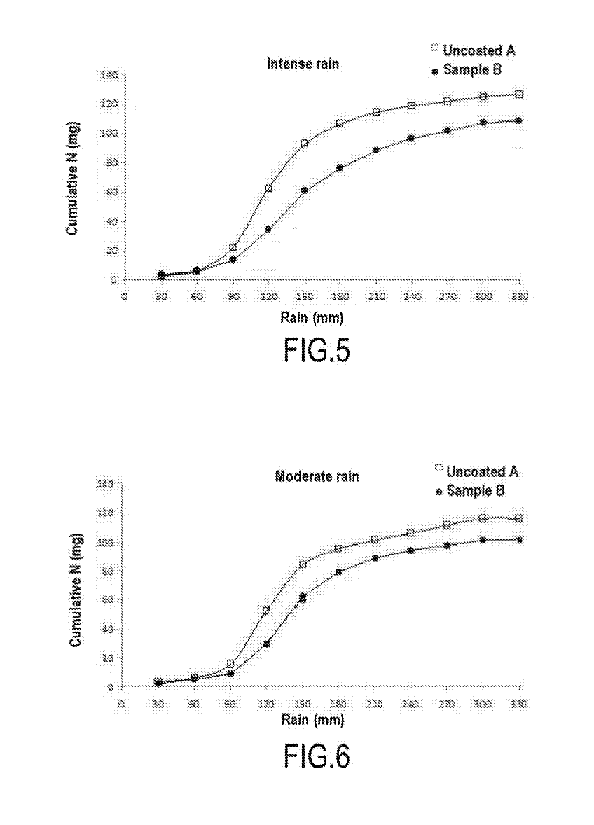

Results: The slow release of potassium demonstrates the effectiveness of sample B: it is less in the case of moderate rain (FIGS. 3 and 4). The coating of the invention does not appear to delay the dissolution of nitrogen, whether in the case of intense rain or of moderate rain (FIGS. 5 and 6).

Sample B releases the potassium very slowly under intense rain, which contributes to the reduction in interchangeable calcium and magnesium losses.

The differences in potassium release profile between the intense system and the moderate system suggest that sample B has a stable equilibrium between potassium protection and release. The more intense the rain is, the more the potassium is protected. When the rain is moderate, the proportion of potassium released is greater.

The fertilizer of the invention clearly makes it possible to modulate the making available of potassium to the plant as a function of the precipitation volume. It is particularly effective when the soil is exposed to intense rains.

D. Results of Open-Field Tests on Soy and on Wheat with Sample B

Agronomics tests were then launched on soy and wheat to compare the effectiveness of the coated fertilizer and uncoated fertilizer.

These results are convincing on soy and on wheat at the respective doses of 150 kg/ha and 200 kg/ha.

### D.1. Test on Soy

The objective of this study was to observe the growth of soy in a greenhouse, and its response in terms of inorganic potassium content.

### Material and Methods

Fertilizer: reference A and B samples of example 1
Doses: 0.25, 0.50, 0.75 and 1.00 g of fertilizer per pot equivalent to 75, 150, 225 and 300 kg of fertilizer per hectare.
substrate: mixture of 15% of clay earth with 85% of sedimentary sand, 10 kg of substrate/pot with four repetitions.
Measurements: dry weight of the shoots, chemical analysis of the plant and chemical analysis of the soil (60 days after the treatment).
Statistical analysis: analysis of variance and t test (P<0.05) to compare the types of fertilizer and regression analysis to estimate the best dose of fertilizer. The dry soy stalks were statistically different between the treatments receiving 150 kg ha⁻¹ of potash fertilizer. At this dose, the statistical test (t) confirms the high effectiveness of sample B during the treatments.

### Results:

The soy growth in a greenhouse was affected by the types and the amounts of potash fertilizers. The highest growth of the soy plants was obtained with 150 kg ha⁻¹ (estimated amount 188 kg ha⁻¹) of potash fertilizer.

At the dose of 150 kg/ha, the maximum growth was obtained with the coated fertilizer according to the invention.

The N, S, Ca and Mg concentration, by dry weight, of the shoots was not affected by the treatments, but the accumulative amounts of N and of S were associated with the growth response.

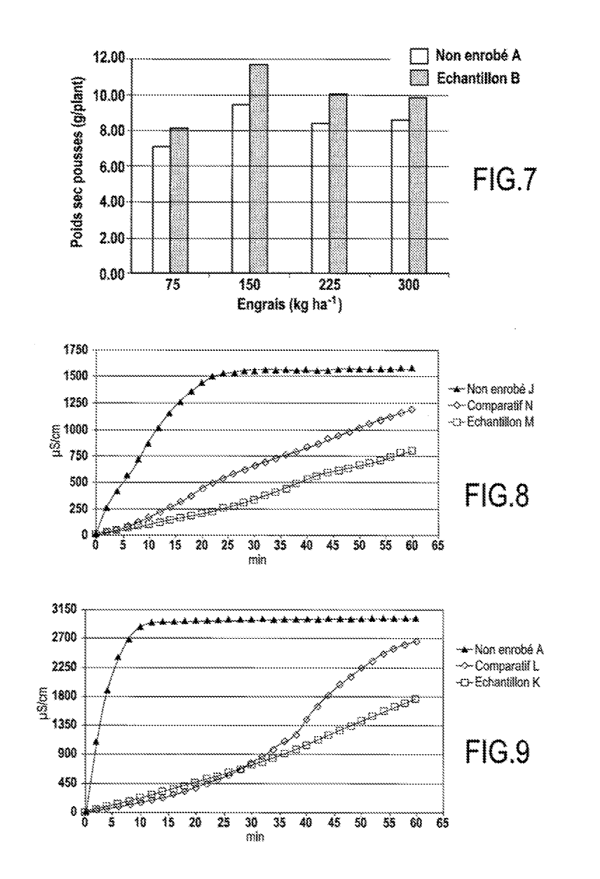

The coated fertilizer according to the invention applied at low and intermediate amounts gives a subsequent absorption of K by the soy compared with the uncoated fertilizer. The N, S, Ca and Mg concentration, by dry weight, of the shoots did not vary, and the growth of the soybeans no doubt results from the higher absorption of K by the plants as brought about by the fertilizer of the invention. The results are presented in FIG. 7.

### D.2 Test on Wheat

The objective of this report is to present the results of the K contents in the leaves and in the seeds in response to the treatment, compared with the samples A and B.

### Material and Methods

Fertilizer: samples A and B of example 1.
Doses: 0, 49 and 98 kg K₂O per hectare equivalent to 0, 100 and 200 kg of fertilizer (3.0.49) per hectare.
   Chemical composition of the soil:
   pH_{(H}_{₂}_{O)} 6.00; Ca 3.50; Mg 0.73; K 0.27; CES 7.01 cmol_{c} dm⁻³; P 16.50 mg dm⁻³; organic carbon 11.7 g dm⁻³; sand 72%; clay 14% and silt 14% g·kg⁻¹.
   Measurements: mineral concentration of the leaves 30 days after fertilization, chemical composition of the soil and seed yield (kg ha⁻¹).

### Results

The foliar concentration of N for sample B was different than that of sample A only at the amount 200 kg ha⁻¹ of potash fertilizer, but did not differ according to the types of fertilizer.

The foliar concentration of K for sample B was different than that of sample A, but it did not differ according to the types of fertilizer.

The amounts of fertilizer applied were not sufficient to increase the K concentration in the soil.

### Comparative Example 2

### Comparison of Talc and of Non-Hydrated Cement

An NPK fertilizer (03-00-49 or 07-00-20), produced by wet granulation, in the form of granules, was coated successively with a resin in aqueous dispersion and then with a non-hydrated cement or with talc.

The following samples were prepared.

| | | | Dose | | Dose |
|---|---|---|---|---|---|
| Sample | Fertilizer | Resin | [kg/T] | Cement | [kg/T] |
| Reference A | NK 3-0-49 | | | | |
| Reference J | NK 7-0-20 | | | | |
| K | NK 3-0-49 | resin R | 30 | 42.5R cement | 80 |
| Comparative L | NK 3-0-49 | resin R | 30 | Talc | 80 |
| M | NK 7-0-20 | resin R | 30 | 42.5R cement | 80 |
| Comparative N | NK 7-0-20 | resin R | 30 | Talc | 80 |

The results of the conductometer tests carried out according to the first method previously described have been reported in FIGS. 8 and 9.

1. A delayed-release fertilizing product comprising fertilizer particles that are coated
with a first layer comprising a resin selected in the group consisting of polysaccharide resins, and resins that are obtained by copolymerization reaction of a vegetable oil with a compound selected in the group consisting of vinyl monomers, polycarboxylic acids and anhydrides, and
with a second layer comprising a non-hydrated cement.

2. The fertilizing product as claimed in claim 1, characterized in that the fertilizer comprises at least one compound chosen from potassium salts.

3. The fertilizing product as claimed in claim 1, characterized in that the resin is a branched polyester resulting from copolycondensation reaction of a vinyl monomer with a vegetable oil, in the presence of an amine.

4. The fertilizing product as claimed in claim 1, characterized in that the resin is a polyester obtained by reacting acrylic acid with an epoxidized vegetable oil, optionally in the presence of a glycol.

5. The fertilizing product as claimed in claim 1, characterized in that the vegetable oil is chosen from castor oil, palm oil, corn oil, soybean oil, rapeseed oil, sunflower oil, sesame seed oil, peanut oil, safflower oil, olive oil, cotton seed oil, linseed oil, coconut oil and tung oil, and mixtures thereof.

6. The fertilizing product as claimed in claim 1, characterized in that the cement is selected in the group consisting of Portland cements.

7. A process for producing a fertilizing product as claimed in claim 1, comprising a step of spraying an aqueous dispersion of the resin onto the fertilizer particles, and a step of adding the non-hydrated cement powder to the resin-covered fertilizer particles.

8. A process for spreading a fertilizing product on soils that may be subjected to an annual rainfall of between 2000 and 3000 mm, said process consisting in using the fertilizing product as claimed in claim 1.
